(19) United States
(12) Patent Application Publication
(10) Pub. No.: US 2012/0180424 A1
(43) Pub. Date: Jul. 19, 2012

(54) CONSTRUCTION MATERIAL HANDLING METHOD AND APPARATUS

(75) Inventors: Foster D. Hinshaw, Cambridge, MA (US); William J. Fosnight, Saratoga Springs, NY (US)

(73) Assignee: Dunmow Systems Corporation, Cambridge, MA (US)

(21) Appl. No.: 13/324,651

(22) Filed: Dec. 13, 2011

Related U.S. Application Data
(60) Provisional application No. 61/422,501, filed on Dec. 13, 2010.

(51) Int. Cl. E04G 21/00; G06F 19/00; E04B 1/00

(52) U.S. Cl. 52/745.02; 52/745.2; 700/95

(57) ABSTRACT

A method of building a structure at a job site, the method comprising dividing the structure into multiple substructures, the multiple substructures defining the structure; selecting at least one construction automation module adapted to assist in assembly of the structure at the job site, the at least one construction automation module provided at the job site; defining a material kit for at least one substructure, the material kit having components; identifying automation assisted components of the material kit as one or more of the components identified to be handled by the at least one construction automation module; fabricating the material kit for the at least one substructure is provided, the components of the material kit being pre-cut to length and size; delivering the material kit to the job site; supplying the automation assisted components of the material kit to the automation component; and assembling the substructure using the automation component.

### RELATED APPLICATIONS

This application claims the benefit of and priority from U.S. Provisional Patent Application Ser. No. 61/422,501 Entitled “CONSTRUCTION MATERIAL HANDLING METHOD AND APPARATUS” and filed on Dec. 13, 2010 which is hereby incorporated by reference herein in its entirety.

### BACKGROUND

1. Field

The disclosed embodiments relate to a construction material handling method and apparatus and, more particularly, to a framing construction method and apparatus adapted to produce framed structures.

2. Brief Description of Earlier Developments

Home or commercial construction projects often involve framing carpentry. Typical construction involves a dimensioned plan and a specification reflecting the desired construction provided to carpenters or a framing crew. The amount of dimensioned lumber is determined, ordered and delivered to the construction site. Although some of the lumber may be provided cut to length, for example, wall studs, much of the lumber needs to be cut to length from larger pieces of the dimensioned lumber. In parallel or after the lumber has been cut to size, framers manually mark the location of the framed construction and manually assemble the structure, typically starting with the sills, floor joists and floor, walls, ceiling and roof in the case of a simple one story home. The process tends to be time consuming and costly as the cutting, measurement, marking, locating, assembly and fastening is manual, time consuming and labor intensive and is subject to inaccuracies due to communication errors and the quality of the carpenters and framing crew. Accordingly, there is a desire to reduce the time, cost and inaccuracies associated with manual home structure supply, framing and sheathing.

### BRIEF DESCRIPTION OF THE DRAWINGS

The foregoing aspects and other features of the exemplary embodiments are explained in the following description, taken in connection with the accompanying drawings, wherein:

FIG. 1 is a isometric view of a job site and support structure;

FIG. 2A is a joist setter;

FIG. 2B is an underside view of the joist setter of FIG. 2A;

FIG. 2C is an underside view of an alternate embodiment joist setter;

FIG. 3A is a panel cart;

FIG. 3B is a top view of a joist setter;

FIG. 3C is a side view of a joist setter;

FIG. 3D is a top view of two joist setters in use;

FIG. 4 is a placement arm;

FIG. 5 is a walking joist or rafter placement arm;

FIG. 6A is a panel trolley and lifter;

FIG. 6B is a panel trolley and lifter;

FIG. 7 is a wall auto level;

FIG. 8 is a wall auto level;

FIG. 9 is a joist or rafter dealer;

FIG. 10 is a joist or rafter dealer;

FIG. 11 is a joist or rafter dealer;

FIG. 12 is a joist or rafter dealer;

FIG. 13 is a joist or rafter dealer;

FIG. 14 is a joist or rafter dealer;

FIG. 15 is section of a rafter and ridge beam;

FIG. 16 is a load offset gripper;

FIG. 17 is a process flow diagram; and

FIG. 18 is a placement arm.

### DETAILED DESCRIPTION OF THE EXEMPLARY EMBODIMENT(S)

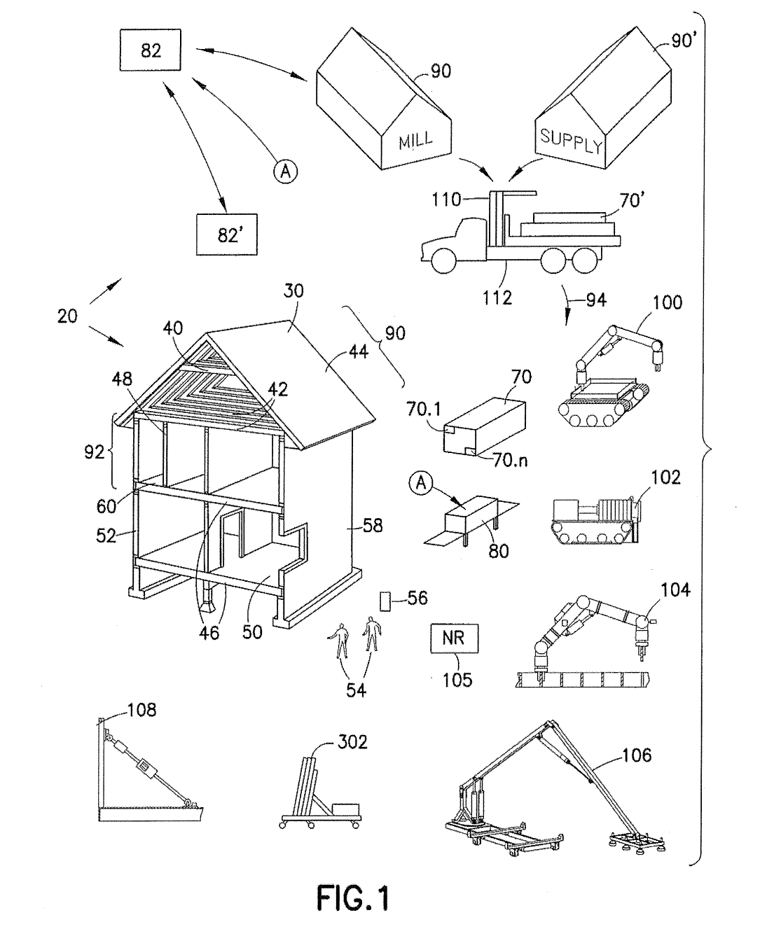

Referring to FIG. 1, there is shown, an isometric view of a job site and support infrastructure to build a structure having framed structure thereon in residential or commercial construction or otherwise incorporating features in accordance with an exemplary method and embodiment. Although the present invention will be described with reference to the embodiments shown in the drawings, it should be understood that the present invention can be embodied in many alternate forms of embodiments. In addition, any suitable size, shape or type of elements or materials could be used.

Job site and support infrastructure 20 has structure 30 made of framed and sheathed components. Although the structure 30 will be described with respect to framed and sheathed components of lumber, any suitable components, for example, metal, polymer, composite, masonry or otherwise may be used. Further, although structure 30 will be described with respect to framed and sheathed components, other components prior, during or subsequent to framing of structure 30 may be applied to the present embodiments. By way of example, interior or exterior trim components, siding or roofing components, hybrid sheathing and siding components, kitchen and bath components, wall finishing components such as sheetrock or otherwise, interior or exterior masonry and supporting structures or other suitable component part or subassembly. Structure 30 may be made of roof rafters 40, ceiling joists 42, roof sheathing 44, floor joists 46, second floor wall studs 48, sub floor 50, 60, first floor wall studs 52, and sheathing 58. In alternate embodiments, more or less components may be provided. In the exemplary embodiment shown, framing material kit 70 is provided to make up a desired structure or portion of a structure and may include components, for example, cross bracing or otherwise required to assemble the structure but not part of the completed structure. Here, structure 30 is divided into multiple substructures with the multiple substructures defining structure 30. For example, roof 90 may be one multiple substructure where ceiling joists and second floor walls 92 may be another substructure. Job site and support infrastructure 20 has available a number of construction automation modules, for example panel cart 100, joist setter 102, placement arm 106, walking joist or rafter placement arm 104, auto level 108 or trolley and panel lifter 302. As disclosed in U.S. Provisional Patent Application Ser. No. 61/422,508 and filed Dec. 13, 2010 entitled “Construction Fastening and Locating System and Method”, which is hereby incorporated by reference herein in its entirety, a nailing device 105 may further be provided and having a locating device (LPS) in communication with controller 82 and/or 82′ or otherwise. The locating device may similarly be utilized with other automation components, tools, materials, assemblies, personnel or any suitable asset used in any aspect of the construction process. In alternate embodiments, more or less automation modules may be provided. For example, crane 110 on truck 112 may be provided or otherwise. In alternate embodiments, crane 110 may be a larger crane and provided as a stand alone crane of any suitable type on site either affixed or moveable. In alternate embodiments, truck 112 may be provided as a platform for construction, for example, where truck 112 has stick machine 80 mounted thereon and transportable to a construction site or otherwise. Further, truck 112 may be provided with any suitable combination of automation modules or modules or tools and materials to assist in the construction. The construction automation modules may be provided adapted to assist in assembly of structure 30 at the job site where the at least one construction automation module is provided at the job site. Construction automation module(s) are selected and adapted to assist in assembly of structure 30 at the job site and provided at the job site. Material kit(s) 70 for the substructure(s) may be defined having components 70.1 . . . 70.n. A subset of the components are identified as automation assisted components of the material kit that may be the entire kit 70.1 . . . 70.n or a subset of the kit and are identified to be handled by one or more of the construction automation modules 100, 102, 104, 106, 108. The material of kit 70 may have features facilitating use of the construction automation modules, for example, jig holes, locating features, handling features, jig features, identification features or fiducials facilitating use of optical character recognition may be provided. In alternate embodiments, more or less features may be provided. Further, the components of material kit 70 may include permanent or temporary jigs, fasteners, tools, plumbing materials, electrical materials, HVAC materials, insulation, automation components or otherwise as required to complete fabrication of the construction materials contained within kit 70. As disclosed in U.S. Provisional Patent Application having Ser. No. 61/422,476 and filed on Dec. 13, 2010 entitled “Frame Construction Method and Apparatus”, which is hereby incorporated by reference herein in its entirety and described by way of example below, the framing components may have mating fastener features, for example, pins and mating sockets that mate during assembly of the structure where the mating features may be applied to any suitable mating portion of structure 30. Definition of the substructure(s), Selection of the construction automation modules, definition of the material kit(s)for the substructure(s) including construction materials, fasteners, tools and other materials, identification of the components and subset of the components as automation assisted components of the material kit and identified to be handled by one or more of the construction automation modules 100, 102, 104, 106, 108 may be accomplished by server 82. A suitable example of server 82 is disclosed in U.S. patent application Ser. No. 13/178,344 filed Jul. 7, 2011 and entitled “Construction Control System” which is hereby incorporated by reference in its entirety. Server may be a Residential Homebuilding Material Control System (RHMCS) 82 that may maintain item and location data real time for design, millwork and construction phases (real-time as-built). System 82 may enable efficient material ordering, scheduling, dispatch, job execution, material management, control of automation, placement of materials, location and status of materials, tools or automation, human safety (location of people) pace-setting, and compliance to codes green initiatives (e.g. Energy Star, LEED, FSC). System 82 determines what automation components will be used and plans for and puts features into the construction materials such as locating holes or features, fiducials, center of gravity locations, lift points, fixturing to accommodate automation or other suitable feature to ease and facilitate efficient completion of the structure. Feedback into system 82 may include data transmitted from automation 100, 102, 106, 108 which may be on or off site, for example, status of task or position of automation and material from local position feedback system(s) as well as data transmitted from humans 54, for example, via smart phone interface 56 with location information. Location and/or status tracking devices may be affixed to any device contributing to the completion of the structure including fabrication materials, fabricated assemblies, automation components, tools, personnel, ancillary materials, plumbing materials, electrical materials, HVAC materials, insulation, fasteners or any other suitable contributor to the completion of the structure. Here, the tracking devices may communicate with system 82 in a one or two way fashion, driving, for example, an automation component to the portion of the site needed or by way of further example, driving additional materials to the site based on completion status. As such, the tracking devices facilitate efficient completion of the structure. System enables streamed (lean manufacturing) as opposed to what is currently batch processing. System 82 may include full visualization capability of shop floor or construction site for remote monitoring. System 82 orders material for the kit(s) from mill 90, supply 90′ or otherwise. In alternate embodiments, system 82 may order the material to be fabricated on site via stick machine or via local controller 82′. As such, the material kit(s) are fabricated for substructure(s) with one or more of the components of the material kit being pre cut to length and size. Components of kit 70 may be placed in a logical order such that as components are removed, they logically are in the order of assembly and may provide all that is necessary, including tools, fasteners or otherwise to complete assembly of the construction materials. In addition to driving materials, system 82 may further drive the delivery location and sequence of delivery facilitating efficient completion of the structure. By way of example, system 82 may drive delivery of sheetrock to a floor during framing and before the floor is enclosed such that availability to the workers is immediate and special equipment is not required, for example, to deliver the sheetrock through a window. As previously described, the components may comprise any desired components that make up the completed structure in addition to supporting components if needed. Although shown made up of stick lumber, kit 70 may contain combinations of materials, for example, stick lumber and sheathing and/or flooring and/or fasteners, tools plans or otherwise required to complete the structure or portion of the structure. Alternately, kit 70 may include prefabricated sub assemblies, for example, wall or floor or other suitable sections or portions which may include components. The lumber may be cut to size manually, semi automatically or automatically on any suitable platform. A suitable example is stick machine 80 is disclosed in U.S. patent application Ser. No. 13/178,138 filed Jul. 7, 2011 and entitled “Automated Stick-Frame System” which is hereby incorporated by reference in its entirety. Stick machine 80 may be provided to manufacture lots of lumber, for example CNC cutting, identification, drilling for electrical or plumbing, marking circuits, electrical boxes etc. . . . In alternate embodiments, more or less functions may be provided. Exemplary stick machine 80 may be an automated system that produces stick-frame construction components, for example, studs, top plates, bottom plates, joists, rafters, blocking or otherwise from standard dimensional lumber. Machine 80 may receive CAD data translated from a framing model in server 82 and may reside on site or off site, for example within mill 90. Stick machine 80 cuts boards to length and may be provided with adjustable miter and bevel, drills holes for electrical and plumbing, marks, for example, board ID, stud locations, hole ID—electrical circuit or plumbing ID, electrical outlet locations, switch locations, data cables or otherwise. Machine 80 may also drill mating features, such as holes or slots for pinned connections to bottom of panels, top of panels, at stud locations or otherwise to permit alignment or otherwise and may install mating pins or features. Stick machine 80 may be fed 2″×3″ through 2″×12″ lumber and may prompt a user to load appropriate board length that minimizes waste of parts to be produced. Machine 80 may be portable to job site or location proximate home construction or located remote such as at site 90. Kit 70 may be assembled at job site 20 as material is fed 92 from machine 80. Alternately, Kit 70′ may be delivered 94 and assembled in real time on site 20. Alternately, Kit 70 may be assembled at a site 90 different than job site 20 and transported or shipped to job site 20. As will be described below, tools or automation, such as modules 100, 102, 104, 106, 108 may be provided to facilitate assembly. In alternate embodiments, any suitable tools or automation may be provided to facilitate assembly. Additionally, a portion or all of the framing components may have identification indicia, with the identification indicia indicating where the mating framing components are to mate and/or indicating which of the mating framing components mate and/or an order that the framing components are to be assembled, a component identification, unique or by group or otherwise and/or any suitable identification indicia. In alternate embodiments, any suitable mating feature, fastener or identification indicia or otherwise may be provided on the components of kit 70 to facilitate ease of assembly, fool proof (poka-yoke) assembly or ease of alignment. In the embodiment shown, the framing components 70 are pre cut to length and size to form at least a portion of the structure 30. By way of example, kit 70 may comprise the framing and sheathing required to assemble the roof structure of structure 30 or alternately, one or more walls having a kit with mating components or floors or otherwise. Material kit 70 or 70′ may be delivered to the job site via truck 112 or other suitable delivery method. Alternately, material kit 70 or 70′ may be fabricated and delivered on site. One or more of the automation assisted components 100, 102, 104, 106, 108 is scheduled and provided on site where the material kit defined for the automation component is provided. By way of example, panel cart 100 may have a pallet of panels loaded from lot 70′ via crane 110. As will be described below with respect to the automation modules, the components of the kits are assembled by substructure utilizing the automation modules, ultimately forming the structure using the automation modules that may work in conjunction in combination with operators and workers.

In the embodiment shown, a system for building a structure 30 at a job site is provided. The system may have at least one material automation fabrication component 80, 90 arranged to fabricate predetermined construction material 70, 70′. Controller 82 may be communicably connected to the at least one material automation fabrication component 80, 90 and programmed to generate commands and instructions for fabrication of the predetermined construction material into at least one kit 70, 70′ of predetermined construction material. Controller 82 may be configured to interface with at least one field assembly automation component 100-108 having a predetermined automation function for sequential erection of structure 30 from the at least one kit of predetermined construction material 70, 70′. Controller 82 may be programmed to associate the at least one kit of predetermined construction material 70, 70′ with the at least one field assembly automation component 100-108 and to generate with the at least one material automation fabrication component 80, 90 the at least one kit of predetermined construction material 70, 70′ associated with the at least one field assembly automation component 100-108. The at least one field assembly automation component may comprise more than one field assembly automation component each with a different field assembly automation function and with controller 82 programmed to generate different kits of predetermined construction material associated with each different field assembly automation function, and with each of the more than one field assembly automation components operating at a different time in a construction build sequence, the different kits of predetermined construction material produced and provided in accordance with the construction build sequence. Here, the at least one kit of construction material may be sequenced for sequential installation by the at least one field assembly automation components in a construction build sequence. At least one kit of construction material may be provided with a corresponding at least one field assembly automation component to the job site in sequence for sequential installation by the at least one field assembly automation components in a construction build sequence. At least one field assembly automation component may comprise more than one field assembly automation component each with a different field assembly automation function, with the controller programmed to generate different kits of predetermined construction material associated with each different field assembly automation function, and with the different kits of predetermined construction material having different handling features associated with each different field assembly automation function. Here, the at least one field assembly automation component may comprise more than one field assembly automation component each with a different field assembly automation function, with the controller programmed to generate different kits of predetermined construction material associated with each different field assembly automation function, and with the different kits of predetermined construction material having different locating features associated with locating each different kits of predetermined construction material with respect to each other.

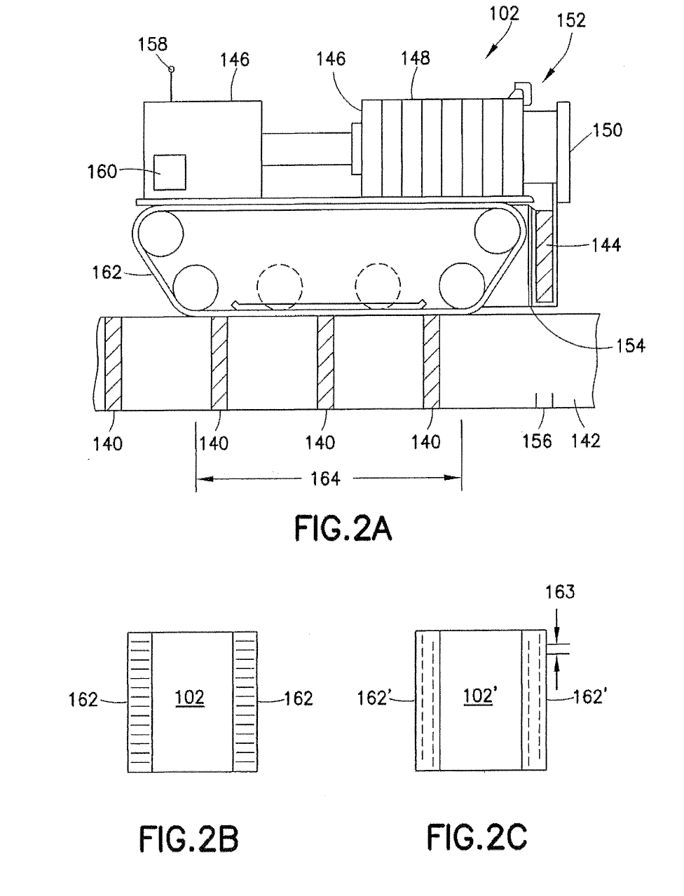

Referring now to FIG. 2A, there is shown joist setter 102. Joist setter 102 is shown on joists 140 that are fastened to sill plate 142. Joist setter 102 progresses perpendicular to joists 140 that have just been placed and presents the subsequent joist 144 to be placed such that operators positioned at each end of joist 144 may quickly and safely fasten it to the respective sill plates or otherwise. Joist setter 102 has indexer 146 provided to index joists to be placed 148 toward vertical indexer 150 and moveable stop 152. Indexer 150 drops joist 144 to an unloading position 154 where joist 144 may be removed by operators. Alternately indexer 150 may position joist 144 in final position 156 for fastening. Joist setter 102 may be controlled via the RHMCS, may detect its position via the LPS and reports its status to the RHMCS via wireless 158 and controller 160. Track 162 of Joist Setter 102 may be a double or single wide band as shown, or alternately resembling a belt sander with a width 164 of at least 2 joist spacings to permit joist setter 102 to travel in all directions on top of placed joists. Joist Setter 102 may be loaded by crane on site 110. In alternate embodiments, joist setter 102 may have multiple tracks, allowing joist setter 102 to turn and adjust angle of motion with respect to the placed joists. Further, in alternate embodiments, Joist setter 102 may not have tracks and instead be indexed and moved by crane 110, either automatically, semi-automatically or manually. Joist setter 102 may be driven automatically by processor 160 after having been downloaded appropriate instructions. In doing so, Joist setter 102 may utilize a combination of machine vision, dead reckoning and guided reckoning using placed joists, local known references and fiducial or otherwise. In alternate embodiments, joist setter 102 may operate in a semi-automatic mode where an operator gives joist setter 102 a high level instruction, for example, to “index one joist and present the next joist” where joist setter 102 incrementally executes the instruction. In alternate embodiments, joist setter 102 may operate in a manual mode where an operator, by remote radio or pendant operates the individual functions of joist setter 102. In alternative embodiments, voice command may be used.

Referring now to FIG. 2B, there is shown an underside view of joist setter 102. In the embodiment shown, two tracks 162, 162 are shown. Referring also to FIG. 2C, there is shown an underside view of alternate embodiment joist setter 102′. In the embodiment shown, the tracks have been replaced with driven rollers 162′, 162′ where each set of driven rollers 162′ has at least two rows of offset rollers, each row having a plurality of rollers and where the offset pitch 163 between the two rows may be half the pitch of adjacent rollers in a given row. Here, the offset pitch 163 will be less than the width of the flat upper surface of a piece of lumber in which setter 102′ must traverse. For example, pitch 163 may be 1.5 inches less twice the maximum board edge radius and less the board width and roller position tolerance at most in order to have a smooth traverse across the board. In alternate embodiments, more or less driven rollers may be provided.

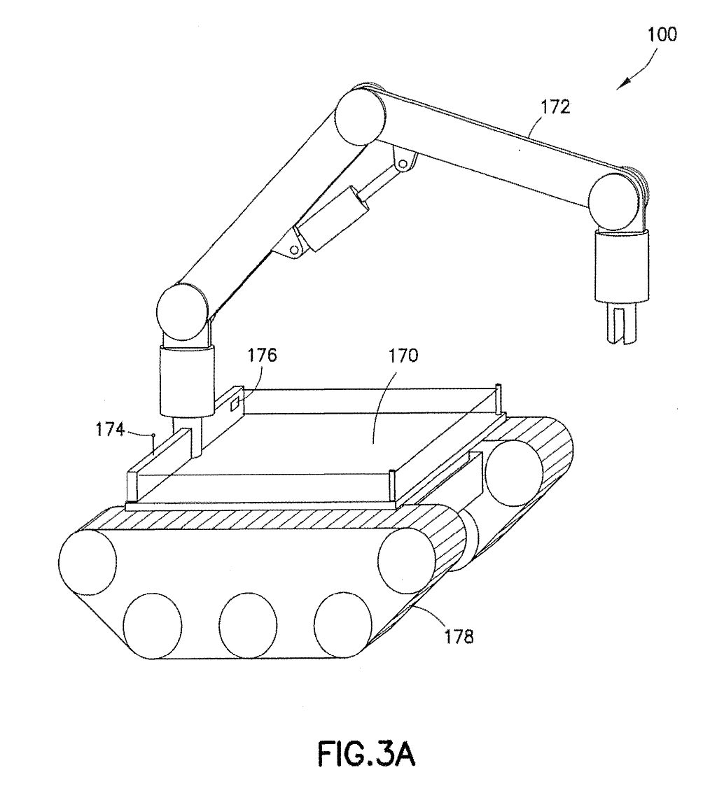

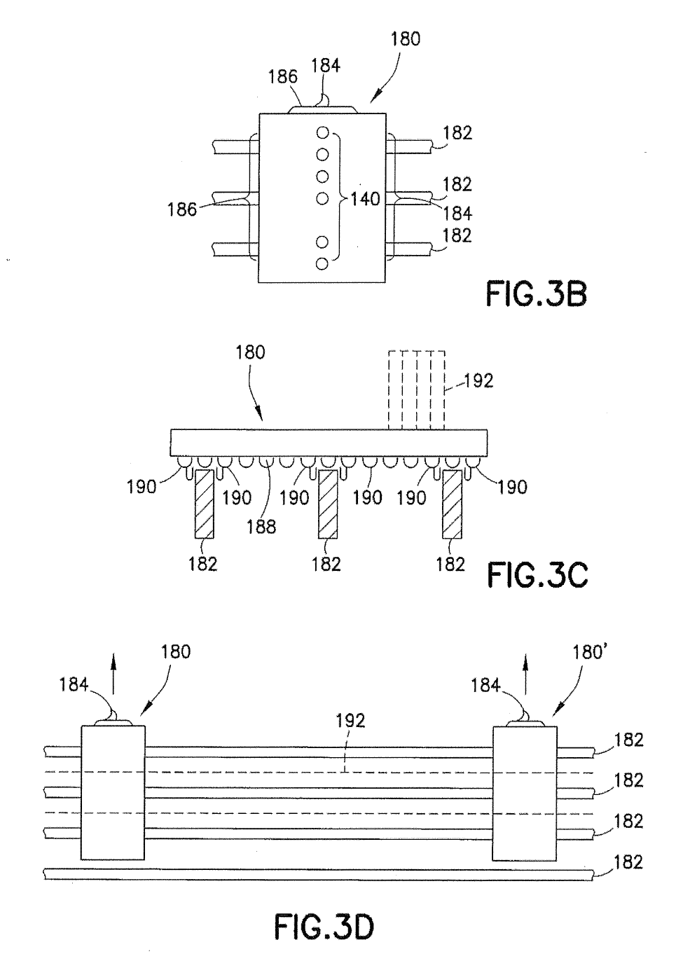

Referring now to FIG. 3A, there is shown panel cart 100. Panel cart 100 may be used to transport sheathing (floor or wall) placed, for example from crane 110 on site into location or hopper 170 to its approximate placement location. In alternate embodiments, panel cart 100 may be used to transport any suitable materials. Panel cart 100 may be track driven as shown or alternately may have pneumatic tires that ride on top of previously placed sheathing or any suitable surface. Panel cart 100 may be used manually, may have device 172 that places the next panel into position automatically or by voice control, or may serve as host to placement arm 106 as described below where device 172 need not be provided. Device 172 may be any suitable device to assist in providing or placing material at the job site. As such, device 172 may be an articulated arm as shown, an indexer to present panels at a consistent level, an indexer to pick a panel off the top of a stack or otherwise to assist in the presentation and/or placement of material on the job site. In alternate embodiments, panel cart 100 may not have arm 172. Panel cart 100 may be controlled via the RHMCS, may detect its position via the LPS and may report its status to the RHMCS via wireless 174 and controller 176. Track 178 of panel cart 100 may be a single wide band as shown. In alternate embodiments, panel cart 100 may have multiple tracks, allowing panel cart 100 to turn and move in any desire direction. Panel cart 100 may be driven automatically by controller 176 after having been downloaded appropriate instructions. In doing so, panel cart 100 may utilize a combination of machine vision, dead reckoning and guided reckoning using local known references and fiducials or otherwise. In alternate embodiments, panel cart 100 may operate in a semi-automatic mode where an operator gives panel cart 100 a high level instruction, for example, to “index one panel and present the next panel” where panel cart 100 incrementally executes the instruction. In alternate embodiments, panel cart 100 may operate in a manual mode where an operator, by remote radio or pendant operates the individual functions of panel cart 100. In alternative embodiments, voice command may be used.

Referring now to FIG. 3B, there is shown a top view of a joist setter. Referring also to FIG. 3C, there is shown a side view of a joist setter. Referring also to FIG. 3D, there is shown a top view of two joist setters in use. Joist setters 180 and 180′ is shown independently moveable on joists 182 that may be fastened to a sill plate. Joist setters 180, 182 may manually be moved upon clamping of brake release 184 on handle 186. Clamping brake release 184 allows rollers 188 to be released and/or pins 190 to be retracted. After clamping brake release 184, one or more users may index joist setter(s) 180, 180′ to the next position where a joist is to be placed, for example, 16″, 24″ or otherwise. Upon release of brake release 184, wheels 188 may be locked and/or pins 190 extended to engage one or more previously placed joists to prevent setter(s) 180, 180′ from moving further. In this manner, users may manually progresses perpendicular to joists 182 that have just been placed and present the subsequent joist(s) 192 to be placed such that operators positioned at each end of joist 182 may quickly and safely fasten it to the respective sill plates or otherwise. Alternately, the two joist setters may incorporate end-nailers that enable fully automated placement and fastening of the joists. Joist setter 180, 180′ may interface with or be controlled via the RHMCS, may detect its position via an LPS on the setter or material or otherwise and reports its status to the RHMCS via wireless and or a controller. In alternate embodiments, joist setter 102 may operate in a semi-automatic mode where an operator gives joist setter 180, 180′ a high level instruction, for example, to “index one joist and present the next joist” where joist setter 180, 180′ incrementally executes the instruction. In alternate embodiments, joist setter 180, 180′ may operate in a fully automatic mode. In alternative embodiments, any suitable combination may be used.

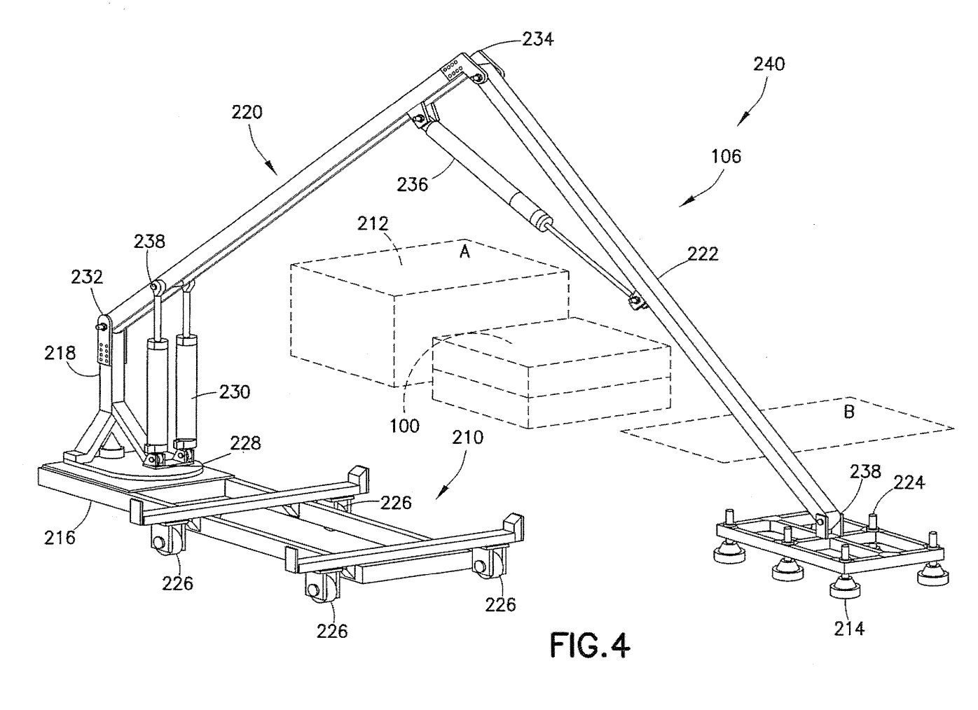

Referring now to FIG. 4, there is shown placement arm 106. Placement arm 106 may be a lightweight articulated arm used by contractors to place sheathing, floor joists, rafters or other building materials into place. Placement arm 106 may be provided attached to sheathing cart 210 and may have the purpose of doing the bulk of material handling associated with any suitable building material placed in cart 210, for example by crane 110. Placement arm 106 may be compliant allowing operators to place material roughly in position where operators may then finally position the material, reducing labor and operator fatigue. In alternate embodiments, placement arm 106 may be provided to place material very accurately in final position. Placement arm 106 may be mounted to cart 210 with materials to be placed on cart 210 or may be separate from a cart 210, for example where placement arm 106 may work with panel cart 100. Alternately, placement arm 106 may access a separate source of material, such as placing from stack of material 212 placed proximate the final installation position by material delivery crane 110 or otherwise. Placement arm 106 may be controlled via a wii controller or similar. Placement arm 106 may also use data from RHMCS to place autonomously or alternately in response to voice commands of an operator. Alternatively, placement arm 106 may be mounted to a wheeled vehicle, or alternately a tracked vehicle capable of traversing floor joists. Alternately, placement arm 106 may move via a gripper at its proximate and distal ends as shown in FIG. 5. Various material grippers may be used by placement arm 5 including jaws for structural components and suction cup surfaces 214 for sheathing and drywall as shown in FIG. 4. Placement arm 106 may include a Local Position Sensor (LPS) that accurately reports its end-position to its controller to allow loose kinematics and fine final positioning. The position sensor data is used to update status to the RHMCS for control and traceability purposes. Placement arm 106 may be used in conjunction with pins that assist with the lead in and accurate positioning of wall panels, sheathing or other components. Placement arm 106 has frame 216 coupled to cart 210, pivot assembly 218, first link 220, second link 222 and gripper 224. Cart 210 is provided with casters to allow movement. Frame 216 is coupled to pivot assembly 218 with turntable bearing 228. Pivot assembly 218 is coupled to first link 220 with rotary joint 232 where first link is actuated by cylinders or linear actuators 230. First link 220 is coupled to second link 222 with rotary joint 234 where second link 222 is actuated by cylinder or linear actuator 236. Compliant linkage 238 couples second link 222 to gripper 224. Although compliant linkage 238 is as shown, in alternate embodiments, compliant linkage 238 may be free to swivel and adjust in roll, pitch and yaw. Alternately compliant linkage 238 may be a ball joint allowing the transported load to be rotated or tilted in any suitable direction. Alternately, compliant linkage 238 may be automated in one or all axis. Placement arm 106 is shown generally as a manual, operator assisted device. In alternate embodiments, each axis may be controlled and driven by a suitable actuator and having position detection capability to autonomously and accurately pick and place materials. Here, placement arm 106 may be driven automatically by processor 238 after having been downloaded appropriate instructions. In doing so, placement arm 106 may utilize a combination of machine vision, dead reckoning and guided reckoning using local known references and fiducials or otherwise. In alternate embodiments, placement arm 106 may operate in a semi-automatic mode where an operator gives placement arm 106 a high level instruction, for example, to “pick a panel at location A and place the panel at location B” where placement arm 106 incrementally executes the instruction. In alternate embodiments, placement arm 106 may operate in a manual mode where an operator, by remote radio or pendant operates the individual functions of placement arm 106. In alternative embodiments, voice command may be used. The placement are can alternately be configured as a passive, manually manipulated SCARA style arm set with actuation only in the z-axis to assist with the lifting and lowering of the sheathing. The z-axis can be operated via a 3-position switch on the manual positioning handle.

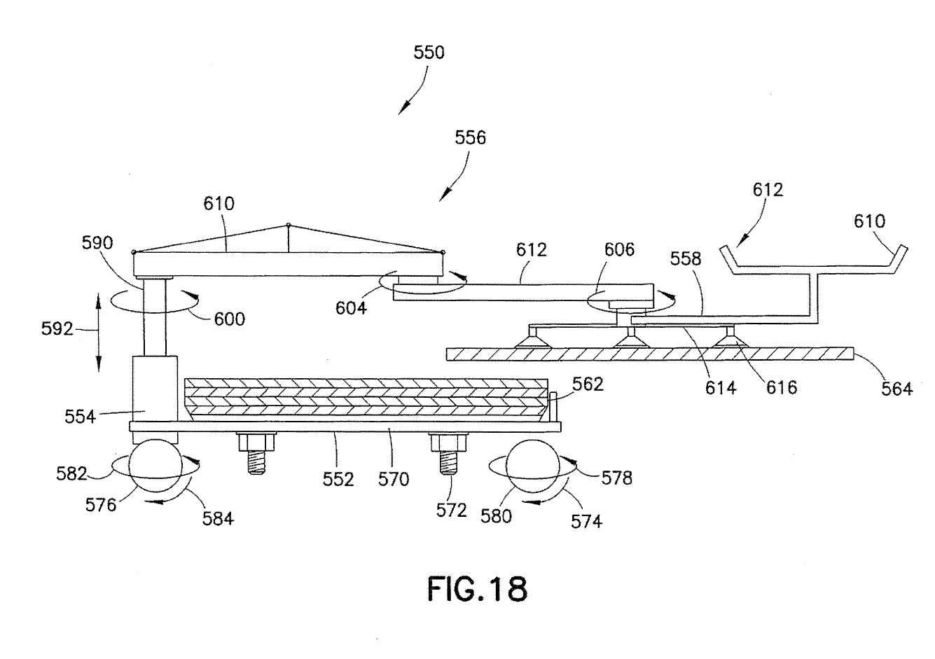

Referring now to FIG. 18, there is shown placement arm 550. Placement arm 550 may be a lightweight articulated arm used by contractors to place sheathing, floor joists, rafters or other building materials into place. Placement arm 550 may be provided attached to sheathing cart 552 and may have the purpose of doing the bulk of material handling associated with any suitable building material placed in cart 552, for example by crane 110. Placement arm 550 may be compliant allowing operators to place material roughly in position where operators may then finally position the material, reducing labor and operator fatigue. In alternate embodiments, placement arm 550 may be provided to place material very accurately in final position. Placement arm 550 may be mounted to cart 552 with materials to be placed on cart 552 or may be separate from a cart 552, for example where placement arm 106 may work with panel cart 100 or otherwise. Alternately, placement arm 550 may access a separate source of material, such as placing from stack of material 212 placed proximate the final installation position by material delivery crane 110 or otherwise. Placement arm 550 may be controlled via a Wii controller or similar. Placement arm 550 may also use data from RHMCS to place autonomously or alternately in response to voice commands of an operator. Alternatively, placement arm 550 may be mounted to a wheeled vehicle, or alternately a tracked vehicle capable of traversing floor joists. Various material grippers may be used by placement arm 550 including jaws for structural components and suction cup surfaces 616 for sheathing and drywall as shown in FIG. 18. Placement arm 550 may include a Local Position Sensor (LPS) that accurately reports its end-position to its controller to allow loose kinematics and fine final positioning. The position sensor data is used to update status to the RHMCS for control and traceability purposes. Placement arm 550 may be used in conjunction with pins that assist with the lead in and accurate positioning of wall panels, sheathing or other components. Placement arm 550 has frame 570 coupled to cart 552, z actuator 554, arm 556 having first link 610, second link 612 and gripper 616. Cart 552 is provided with casters 576, 580 to allow movement. Casters 576, 580 may rotate in directions 582, 584 and 574, 578 respectively where a pair of casters 576 may be powered in a semi automatic mode to assist the operator or in a fully automatic mode to autonomously move cart 552 to a desired location. Casters 580 may be passive casters. In alternate embodiments, any suitable casters, drive or support may be provided. Holding nailers may be provided attached to frame 570 to temporarily lock cart 552 in place during use. Arm 556 is coupled to frame 570 via z actuator 554 where z actuator 554 has z axis drive 592 and rotary axis 590 rotatable in direction 600. Here z axis 554 may be powered or preloaded to assist an operator in lifting panel 564 or otherwise from material stack 562. Rotary axis 590 may be powered or may simply be an unpowered rotary axis. Similarly, rotary axis 604 and 606 may be powered or may simply be an unpowered rotary axis. Here, link 610 is coupled to z actuator 592 with rotary axis 590. Linkage 612 is coupled to linkage 610 with rotary axis 604. Operator guided sheathing placement link 558 is coupled to link 612 with rotary axis 606 and has suction chuck assembly 614 and operator handle 610. Control of z actuator 592 may be done by a user with interface or switch 612. In the embodiment shown, an operator may pick sheathing 564 from material stack 562 and lift it with z actuator 592 and move panel 564 parallel to the floor or work surface and place panel 564 to a desired location. Placement arm 550 is shown generally as a manual, operator assisted device. In alternate embodiments, each axis may be controlled and driven by a suitable actuator and having position detection capability to autonomously and accurately pick and place materials. Here, placement arm 550 may be driven automatically by a processor after having been downloaded appropriate instructions. In doing so, placement arm 550 may utilize a combination of machine vision, dead reckoning and guided reckoning using local known references and fiducials or otherwise. In alternate embodiments, placement arm 550 may operate in a semi-automatic mode where an operator gives placement arm 550 a high level instruction, for example, to “pick a panel at location A and place the panel at location B” where placement arm 550 incrementally executes the instruction. In alternate embodiments, placement arm 550 may operate in a manual mode where an operator, by remote radio or pendant operates the individual functions of placement arm 550. In alternative embodiments, voice command may be used. The placement are can be configured as a passive, manually manipulated SCARA style arm set with actuation only in the z-axis to assist with the lifting and lowering of the sheathing. The z-axis can be operated via a 3-position switch on the manual positioning handle.

Referring now to FIG. 5 there is shown walking joist or rafter placement arm 104. Rafter placement arm 104 is shown having first gripper 250 gripping stationary joist 254 and second gripper 252 gripping to be placed joist 256. Although gripper 250 is shown gripping a single joist 254, in alternate embodiments, gripper 250 may grip multiple joists or may have features, such as supports that extend to one or more joists for stability. In operation, rafter placement arm 104 picks material, for example, joist 256 from a source of material, for example cart 100 and places the joist in position to be fastened, for example position 272. In alternate embodiments, any suitable material may be picked and placed, for example roof rafters or otherwise. Rafter placement arm 104 progresses perpendicular to the joists that have just been placed and presents the subsequent joist to be placed such that operators positioned at each end of the joist may quickly and safely fasten it to the respective sill plates or otherwise. Rafter placement arm 104 may progress until rafter placement arm 104 can no longer reach subsequent rafters or joists placement position, at which point, rafter placement arm 104 “walks” to a new position where gripper 252 grips the last rafter or joist placed and fastened. While gripper 252 remains gripped rafter placement arm 104 releases gripper 250 and raises gripper 250 to clear the framed floor. Gripper 250 is then moved horizontally or otherwise toward the nearest joist to gripper 252 with which gripper 250 can grip and gripper 250 subsequently grips the nearest joist to gripper 252 with which gripper 250 can grip. Gripper 250 is then released and the framing procedure can then proceed where cart 100 also indexes to be accessible by rafter placement arm 104. This sequence is repeated such that the roof section, floor section or otherwise are completed. In the embodiment shown, placement arm 106 is shown as an articulated robot or device having first wrist 258, first joint 260, first link 262, second joint 264, second link 266, third joint 268 and second wrist 270. First link 262 may have modular link section 274 and second link 266 may have modular link section 276 where the modular link sections may be interchangeable with modular link sections, for example, with different length to allow placement arm 106 to perform different tasks. The modular link sections may have quick disconnects to allow ease of fastening for coupling, electrical, hydraulics or otherwise. A high energy density power source 278 driving hydraulic pump 280 may be provided to eliminate the need for power cords driving hydraulic motors and/or cylinders for each axis. In alternate embodiments, any suitable power source or actuator(s) may be provided, for example electric power source either by rechargeable pack or power cord. Camera(s) 282 may be provided to allow a user to oversee operation of rafter placement arm 104 to prevent human interaction where the user may simply be acting as an observer or may be interacting with joist or rafter placement arm 104 as required. Joist or rafter placement arm 104 may be controlled via the RHMCS, may detect its position via the LPS and reports its status to the RHMCS via wireless 284 and controller 284. Joist or rafter placement arm 104 may be driven automatically by processor 286 after having been downloaded appropriate instructions. In doing so, joist or rafter placement arm 104 may utilize a combination of machine vision, dead reckoning and guided reckoning using placed joists, local known references and fiducials or otherwise. In alternate embodiments, joist or rafter placement arm 104 may operate in a semi-automatic mode where an operator gives joist or rafter placement arm 104 a high level instruction, for example, to “index and present the next rafter” where joist or rafter placement arm 104 incrementally executes the instruction. In alternate embodiments, joist or rafter placement arm 104 may operate in a manual mode where an operator, by remote radio or pendant operates the individual functions of joist or rafter placement arm 104. In alternative embodiments, voice command may be used.

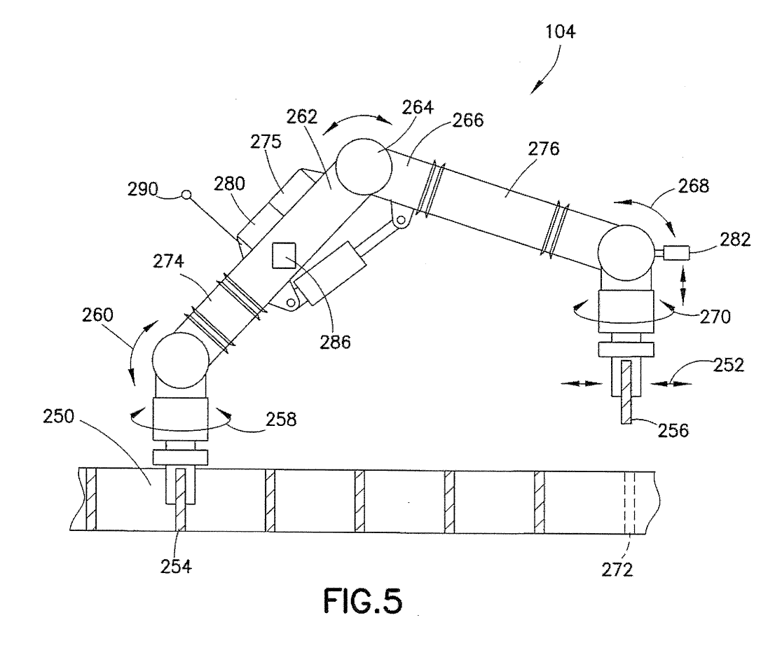

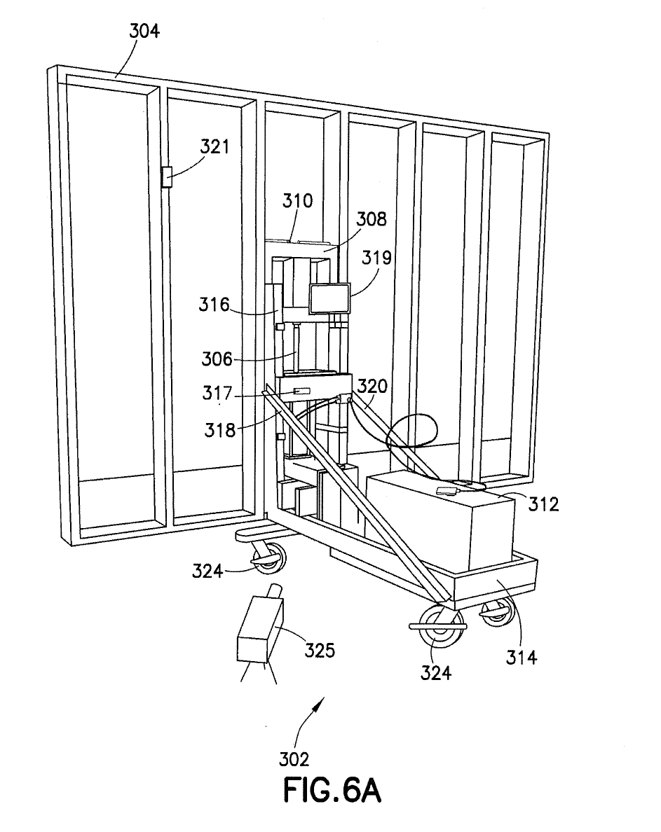

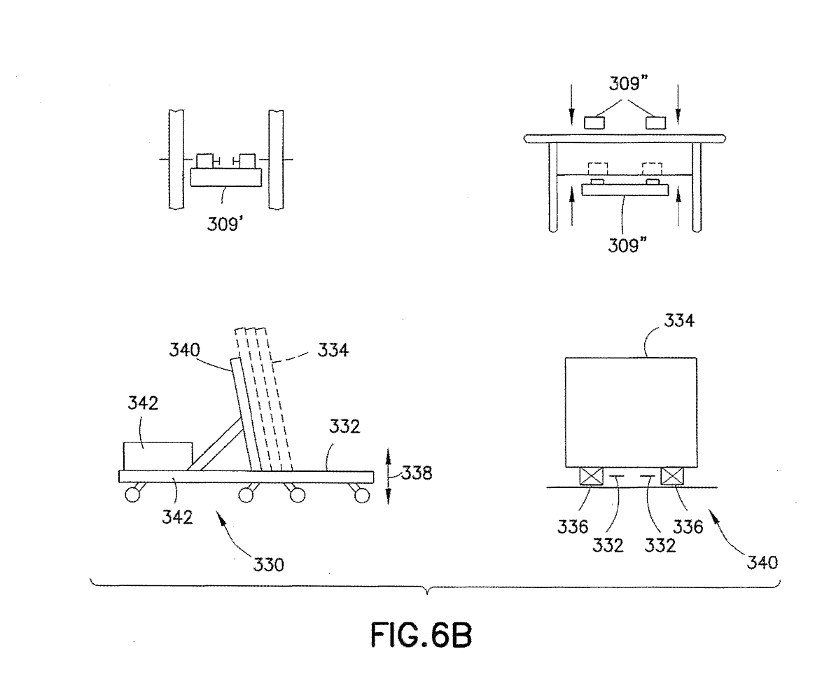

Referring now to FIG. 6A, there is shown panel trolley and lifter 302. Panel trolley and lifter 302 lifts panel 304, for example, sufficiently high to allow the base or sheathing lap of panel 304 to clear the floor being transported over and assists in movement or placement of panel 304 either manually, semi automatically or automatically. For example, panel trolley and lifter 302 may operate autonomously in an automatic mode. As a further example, panel trolley and lifter 302 may operate semi autonomously in a semi automatic mode where an operator operates panel trolley and lifter by use of a high level instruction, remote control or otherwise. By way of further example, panel trolley and lifter 302 may operate manually in a manual mode where operators move panel trolley and lifter 302 from a location to pick panel 304 and to a further location to place panel 304. Panel trolley and lifter 302 may be used very generally, for example, in the millwork facility to assist in handling pre fabricated panels as well as at the construction site to assist in the transport and accurate placement of wall panels, for example wall panel 304. As a further example, more than one panel trolley and lifter 302 may be provided at a job site to assist in panel installation in parallel or to aid in initial panel to floor assembly where, for example, a corner is installed as a starting portion where two panel trolley and lifter 302 are utilized to support the two adjacent corner panels during installation. Panel trolley and lifter 302 may have location device 317 and processor, display and/or GUI 319 to track and identify location of the panel and to provide feedback to system 82 and to identify next steps or otherwise provide an interface for and feedback to operators. System 82 may provide real time sequencing of operations to be performed by panel trolley and lifter 302. Alternately, system 82 may download a series of operations to be performed by panel trolley and lifter 302. Similarly, panel 304 may have identification or location device 321 to allow panel trolley and lifter 302 and/or system 82 to identify the panel and location. In use, panel trolley and lifter 302 may lift a panel, read the ID of the panel, either locally or in conjunction with system 82, the processor and display 319 tells the user where to place the panel. The designated location may be the on site final location, in inventory or otherwise. If the incorrect panel is selected, processor and display 319 may direct the user to leave the panel, move the panel to a different location or otherwise where the processor or display may direct the user to the appropriate next panel to be handled. Location device 317 and/or location device 321 may be used in conjunction with processor and display 319 or system 82 to prevent mishandling. System 82 may track progress of the construction and with system 82 having both CAD data and actual progress and position data and with system 82 in communication with processor and display 319, and/or location device 317 and/or location device 321, as such, mishandling may be prevented. For example, one or both location devices 317, 321 may be used to sense location of the panel and trolley where an edge of the structure may be detected and brakes applied to the casters of panel trolley and lifter 302. Further, an alarm, such as a beeping sound may be made to alert operators and, in conjunction with the brakes, avoid damage or injury. Further, camera 325 may be provided on panel trolley and lifter 302 to allow a user to view or pan on display 319 the interface between the panel and the floor. In alternate embodiments, more or less cameras in different location may be provided. Display 319 may further be used to give center of gravity location and/or weight of the panel and may give information useful to the installation or handling of the panel, such as destination, routing or any suitable information. Panel trolley and lifter 302 includes the capability to lift the panel using pneumatic cylinder 306 mounted to frame 314 as a guided, linear actuator or suitable equivalent. In alternate embodiments, any suitable means of lifting may be provided, for example, hydraulic, lead screw, cam or any suitable method. Cylinder 306 may further have an accumulator with a control associated with the effective size of the reservoir such that workers may lift or lower the panel with little force once handled by panel trolley and lifter 302 and where the control effectively changes the stiffness of cylinder 306. Cylinder 306 is shown mounted within vertical frame 316 and having gussets 318, 320 to provide rigidity. Hand holds may be provided on frame 316, gussets 318, 320 or otherwise to facilitate movement. In alternate embodiments, vertical frame 316 may be further integrated into frame 314. In alternate embodiments, any suitable mounting may be provided. Panel trolley 302 grips a back portion 308 (for example, a horizontal board with holes or blocking or otherwise planned by system 82 and implemented in the panel in advance proactively planning for and anticipating the use of panel trolley and lifter 302) of wall 304 using pins in holes 310 that may be drilled by Stick Machine 80 or otherwise. In alternate embodiments, any suitable gripping may be provided, for example, rigid or non-rigid grasping of panel 304 may be provided or single or multiple attachment points may be provided. The gripper on panel trolley and lifter 302 may be vertically or horizontally adjusted and locked to accommodate different panel types and a range of grip locations. Such locking may be interlocked with lifting capability. The gripper on panel trolley and lifter 302 may have any suitable configuration. By way of example, gripper 309′ is shown positioned between two studs and having two pins that slide into pre positioned holes in the studs. By way of further example, one or more pins may be used in conjunction with gripper 309′ where the pin is removably driven into a pre planned hole in the lower portion of the panel to provide additional stability. By way of further example, gripper 309″ may be provided with pins that locate in pre planned recesses in a header where gripper 309″ clamps from below and above the header. Gripper 309′ and 309″ may be interchangeable for different needs. In alternate embodiments, more or less interchangeable grippers may be provided. Panel trolley and lifter 302 may be counterweighted with load 312 in frame 314 to ensure safe transport and lifting. Frame 314 may be designed to accept commonly available construction components to minimize the transported weight of panel trolley and lifter 302. In alternate embodiments, load 312 may be further integrated into frame 314. Casters 324, locking or otherwise, may be provided and coupled to frame 314 to allow movement of lifter 302 and panel 304. Casters 324 may be manually lockable or braked or may be braked or lockable by way of processor 319. Casters 324 allow panel trolley 302 to easily move in any direction and lock location with locking casters. In alternate embodiments, lifter 302 may be provided with automatic, semi automatic or manual powered movement where operator labor may be minimized. In one embodiment, panel trolley and lifter 302 may be autonomous. In another embodiment, panel trolley and lifter 302 may have assisted movement, for example, by way of electric drives or otherwise. Either pressure in the cylinder 306 or a load cell between cylinder 306 and load 304 may be monitored and controlled to measure and control lifting force to ensure the panel 304 is not being overloaded and permits the wall 304 to be lifted with suitable force to allow it to be easily slid into position, for example, by using pins or otherwise to locate panel 304 with respect to a desired position. In alternative embodiments, an accumulator may be used to permit compliance in the lifting force such that operators may push down on the wall panel once it is at its final position.

Panel trolley and lifter 302 utilizing cylinder 306 may incorporate a calibrated bounce feature as will be described where the bounce feature may apply to any of the disclosed embodiments, any suitable load transport or automation or otherwise. Here, the weight of the carried object may be borne by the transport device where the user may more easily move the object being transported for final placement and where such a feature may be useful with any suitable device used in the transport of objects or where objects are lifted or held up and require final placement in construction or any other suitable application. By way of example, where panel lifter 302 lifts a panel, for example, 700 pounds, cylinder 306 may have a cross section, for example, of 14 inches. If cylinder 306 is extended 1 inch when the panel is in position and 1.5 inches when the panel is hovering, a large force, for example, 350 pounds may be required to push the panel in place. By utilizing a reservoir, for example of 150 cubic inches, the effective cross section of the cylinder may be increased and the force to put the panel in position may be reduced, for example, to less than 30 pounds. As such, the system enables the effective weight or “bounce” to be presented to the user allowing easy placement of panel 304. Further, the “bounce” works in both lifting and lowering directions. For example, where the load on cylinder 306 equals the weight of panel 304 when the elevation of panel 304 is resting on the floor, a user may gently lift panel 304 and, utilizing the casters of panel trolley and lifter 302, may move the panel to a desired location. The effective weight of the panel may be adjustable, for example where the pressure applied to the cylinder or reservoir and the effective volume of the reservoir may be variable. The adjustment may be made by determining the actual weight of the load and the desired effective weight. The actual weight may be determined from prior knowledge, for example through interaction with the RHMCS or other data source. Alternately, the weight may be determined by the pressure required to lift the load or by a load cell or otherwise. Panel trolley and lifter 302 may have controls where the effective weight or “bounce” may be set automatically or manually or otherwise. By way of example, a user may give a hover command where panel trolley and lifter 302 knows the weight and target position of the panel from the system software or otherwise. A desired effective weight, bounce and decent rate may have been programmed into panel trolley and lifter 302 via the system software or by manual entry or otherwise. When the user gives a hover command, valves are opened where the panel descends at a predetermined rate and where the reservoir is filled to an appropriate pressure for the desired effective weight and bounce. Using feedback from sensors, panel trolley and lifter 302 stops dropping the panel when it reaches the desired hovering point, for example ½″ from the floor. The panel lifter maintains pressure to maintain the desired conditions. In alternate embodiments, feedback may be placed on panel trolley and lifter 302 where after a panel is held down on the floor and stationary for a given time, panel trolley and lifter 302 releases additional pressure where the panel is either touching the floor with a predetermined load less than the weight of the panel or resting on the floor or otherwise. In an alternate embodiment, the bounce may be achieved by utilizing a vertical lift with two cylinders acting together where the cylinders may be of the same or different sizes and where both cylinders participate in lifting. For example, 2 cylinders may be placed in line and back to back where maximum bounce at a hover position may be achieved with one cylinder fully retracted with the other extended for the height of the hover position. In an alternate embodiment, the bounce may be achieved with a single cylinder where there is another lifting device present. For example, where a crane is involved a secondary cylinder may be placed between the load and the crane acting effectively as a variable spring or variable air cushion. As previously described, sensors may determine apparent weight and the pressure controlled to maintain an apparent weight profile of the panel over time and over state (position, hover, place or otherwise). Further, as previously described, a reservoir may be added to control the effective weight or bounce through control of the reservoir pressure. In alternate embodiments, the principles described may be used on any suitable load transport application. For example, the cylinders used in load or placement arm 106 may utilize the reservoirs or other implementations to control effective stiffness, weight and bounce as required to ease placement and movement of any suitable payload.

Referring now to FIG. 6B, there is shown alternate embodiment panel trolley and lifter 330. Panel trolley and lifter 330 may have similar features as panel trolley and lifter 302. In the embodiment shown, panel trolley and lifter 330 further has forks 332 allowing panel trolley and lifter 330 to lift one or more panels 334 where panels 334, for example, may be multiple wall sections and are provided with blocks 336 to allow forks 332 to pass below panels 334 and lift or lower 338 the panels 334. Rear portion 340 of panel trolley and lifter 330 may be tilted back as shown to move the center of gravity further in order to minimize the amount of counterbalance weight 342 required. The frame portion 344 of panel trolley and lifter 330 may be configured to accept commonly available construction materials, such as cinder blocks, block, water, lumber or otherwise in order to keep the weight of panel trolley and lifter 330 to a minimum for ease of transport.

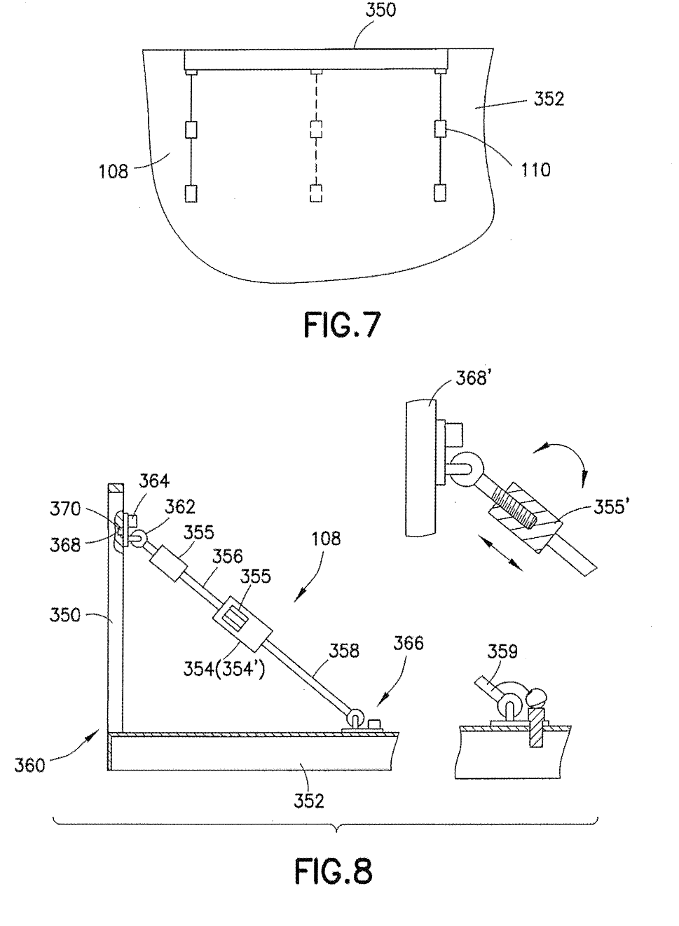

Referring now to FIG. 7, there is shown a top view of wall auto levels 108, 110. Referring also to FIG. 8, there is shown a side view of wall auto level 108. Wall 350 is shown supported by floor 352. In the embodiment shown wall auto levels 108, 110 are placed on either end of panel 350 and may work independently to level or square up wall panel 350 at either end. In alternate embodiments, a single wall auto level 108 may be provided, for example in the middle of panel 350. Further, in alternate embodiments, more than two wall auto levels may be provided, for example, where panel 350 is much longer where supporting only the ends would not ensure level in the middle of panel 350. Wall Auto-Level 108 may be a brace used to hold wall panel 350 vertically before being fastened to an adjacent wall, brace or otherwise. Wall Auto-Level 108 may incorporate turn-buckle like device 354 that can be either manually or automatically driven to extend or retract members 356, 358 of brace 108 situated at approximately 45 degrees between the floor 352 and wall 350. Device 354 may be a turnbuckle like device, automated turnbuckle device, linear actuator or any suitable device. A coarse adjustment 355 may be used to roughly get auto level 108 close to the final position. Adjustment 355 may allow a user to extend or retract the effective length of auto level 108 by disengaging a clamp, rachet or otherwise, extending or retracting the effective length and re engaging the clamp. In alternate embodiments, a combination clamp and turnbuckle 355′ may be provided where coarse adjustments may be made by disengaging a clamp and extending or retracting the effective length of the auto level to get coarse position and subsequently engaging the clamp and rotating the housing about fixed threads to dial in the length of the auto level. Wall Auto-Level 108 may be secured into holes in the studs of the wall panels, drilled or predrilled by Stick Machine 80 or otherwise with fasteners or attached by a clamp or other suitable method of fastening. In alternate embodiments, Wall Auto-Level 108 may be secured using holes, marks, standardized locations, predetermined locations or otherwise. By way of example, hole 368 may be predrilled by stick machine 80 at a predetermined or optimized location and interface with pin 370 of wall auto level 108 such that wall auto level 108 is used consistently and optimally. By way of further example, hole 368′ may be pre drilled in the vertical stud where a right angle post at the upper portion of the auto level may be inserted and pivot. The bottom end of wall auto level may be secured similar to the top portion. In alternate embodiments, bottom portion 309 may be secured in a pre drilled hole, where the hole may be positioned in a location where another wall member will cover if possible. The lower portion 359 may be secured with a pin that has a quick release detachment function and where the pin is captured with lower portion 359 by a lanyard or otherwise. In each case, the lower and upper attachment points may be pre configured and pre drilled as defined within system 82. The bottom end 360 of wall 350 may be secured at a predrilled hole in the subfloor or nailed into place. Alternately, wall 350 may be movable laterally while level 108 is installed. Wall 350 may be measured by a level and the length of Wall Auto-Level 108 adjusted manually by rotating turnbuckle 354. Upper end 362 of wall auto-Level 108 may include an electronic level 364 that runs parallel to the wall panel. In one embodiment, the electronic level 364 gives an audible or visual indication of the level of wall 350 where an operator rotates turnbuckle 354 until wall 350 is level as signified by an audio or visual indication by level 364. In still an alternate embodiment, electronic level 364 may sends data to an automated turnbuckle or similar length extending device 354′ to bring the wall to a true vertical position. In an alternate embodiment, wall auto level 108, 110 may be integrated with panel lifter 302 where panels may be accurately placed in a level orientation. Further in an alternate embodiment, electronic floor level 366 may be provided and coordinated with wall level 364 to ensure they are respectively square. Wall auto-Level 108 may have processor, display or electronic readout 355 for displaying information with respect to wall auto-Level 108, for example, status, next location for use or otherwise. Processor 355 may have capability to communicate with central system 82 or other suitable components or systems to transmit and or receive data, for example position, status, level, next step or any suitable information.

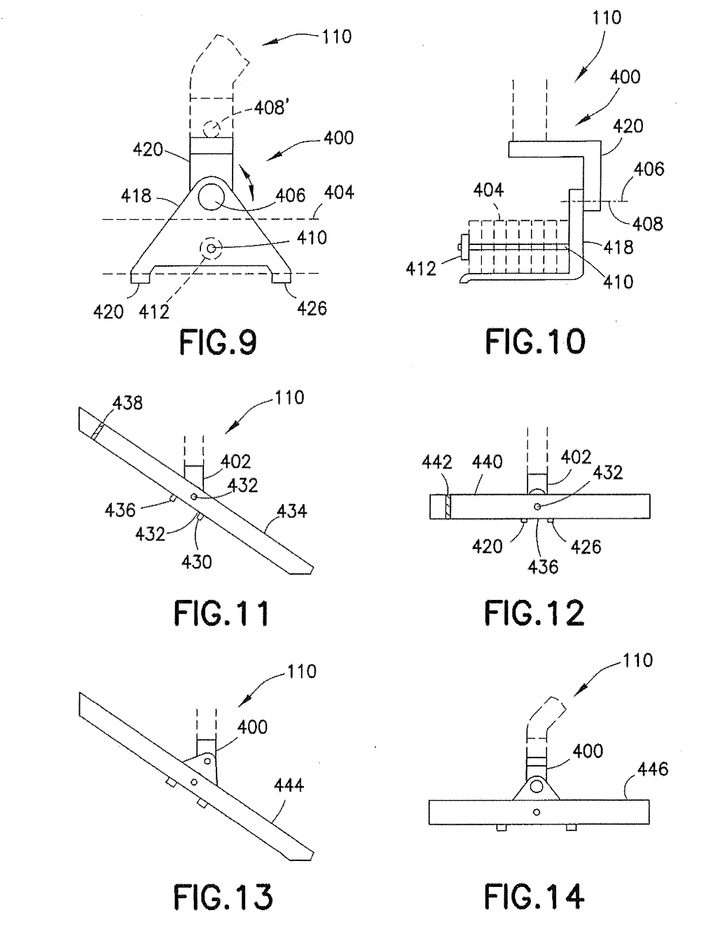

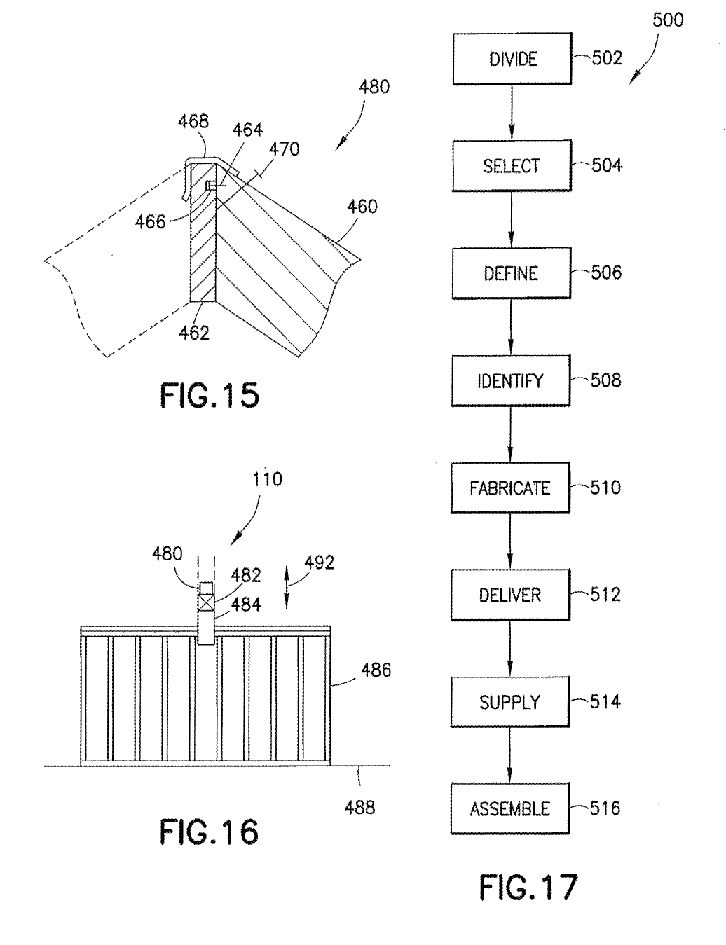

Referring now to FIG. 9 there is shown a front view of joist or rafter dealer 400. Referring also to FIG. 10 there is shown a side view of joist or rafter dealer 400. Joist or rafter dealer 400 is shown as carriage 418 and mount 420 lifted by crane 110 with series of rafters 404 held in place at an angle of a roof floor or otherwise. In the embodiment shown, rafters or joists 404 are shown horizontal however dealer 400 may have actuator 406 rotatable about axis 408 to position rafters or joists 404 at a desired angle. In alternate embodiments, axis 408 may coincide with the center of gravity of joists or rafters 404 as will be shown below. In alternate embodiments, actuator 406 may not be provided, for example where the joint at 406, 408 is not provided and where portions 420 and 418 are unitary and fixed together and where joist or rafter dealer 400 rotates about axis 408′ at the location where joist or rafter dealer 400 couples to crane 110 with the pivot at the crane connection. In the embodiment shown, crane 110 may index a fixed distance, for example 16 or 24 inches or otherwise, and sets joists or rafters manually, semi automatically or automatically where the joists may come direct from mill 90 or machine 80, are loaded on joist or rafter dealer 400 and installed directly, for example, for a floor or roof. In the embodiment shown, pin 410 is provided through a hole in the center of rafters 404 to prevent slide-out. Here, Pin 410 may go through multiple rafters or joists 404 and may have securing nut 412 to prevent dropping material. In alternative embodiments, a nut with a safety strap may be provided where pin 410 is threaded and is rotated with an actuator to allow the nut to come off without a user touching the nut. In alternative embodiments, a nut with a keyed feature may be used and rotated such that a matching feature in the material transported aligns allowing material removal. Alternately, pin 410 may be provided at an angle such that rafters or joists are urged so as not to fall off during transport. Alternately, where safety nut 412 is provided, pin 410 may be provided at an angle so rafters or joists are more easily removed. Joist or rafter dealer 400 may hold 6, 8 or more rafters where in alternate embodiments, more or less rafters may be provided. In use, operators at a ridge beam and a top plate retrieve rafters from joist or rafter dealer 400 and secure into place while dealer 400 indexes to the next location, for example, 16 or 24 inches on center. As shown and will be described with respect to FIG. 15 below, Rafter Pinning may be used to quickly, accurately and safely register rafters to a ridge beam. Joist or rafter dealer 400 may be moved by knuckle boom crane 110 either manually, semi-automatically or automatically. Alternately, any suitable crane may be used, for example, straight boom crane, tower crane or other crane at the installation site of the rafters or joists. While operators nail a given rafter into place, crane 110 indexes to the next rafter installation position. A setting may be provided on joist or rafter dealer 400 that enables angle to be adjusted to math roof pitch or flat for joists. Holes may be drilled at joist or rafter 404 center of gravity or appropriate location in rafters and joists 404 to ensure balance. In some embodiments, the hole location may need to shift as rafters are paid off to compensate for changes in the center of gravity of the remaining rafters and the dealer 400 where system 82 anticipates the shift and accommodates the shifting hole locations in the rafters. In alternate embodiments, more or less holes may be provided and/or more or less capture and/or supporting features may be provided. Yoke 418 is provided with supporting forks 424, 426, where, similar to pin 410, forks 424, 426 may be provided at an angle such that rafters or joists are urged so as not to fall off during transport and where operators may have to lift the joists or rafters for placement and where the angle may be between 10 and 20 degrees or any suitable angle, more or less. Alternately, for example, where safety nut 412 is provided, forks 424, 426 may be provided at an angle so rafters or joists are more easily removed. Yoke 418 is provided with supporting forks 424, 426 where yoke 418 may be set at any suitable angle, for example, to match the roof pitch, floor or any suitable angle. The angle may be set by actuator, manually and locked, or where the pivot is loose and gravity determines the angle based on the balance of the joists or rafters 404 where the hole in joists or rafters is determined based on both the center of gravity of the rafters and the yoke. In the embodiment shown, yoke 418 has pivot 408 where the pivot 408 is offset from the center of gravity of the material. In alternate embodiments, the center of gravity of the rafter is determined when the rafter is at the pitch of the roof where the rafter will naturally tend to that position.

Referring now to FIG. 11 there is shown joist or rafter dealer 402. In the embodiment shown, rafter dealer 402 has yoke 430 that pivots about the center of gravity 432 of rafters 434. In the embodiment shown, yoke 430 may also have the same center of gravity as location 432 as rafters 434 such that the load will remain balanced regardless of how many rafters 434 are in place. Where forks 436 are not provided, safety strap 438 may be provided where rafters 434 may tend to the appropriate angle and be retained as a bundle until installation.

Referring now to FIG. 12 there is shown joist or rafter dealer. In the embodiment shown, joist or rafter dealer 402 has yoke 430 that pivots about the center of gravity 432 of joists 440. In the embodiment shown, yoke 430 may also have the same center of gravity as location 432 as joist 440 such that the load will remain balanced regardless of how many joists 440 are in place. Where forks 436 are not provided, safety strap 442 may be provided where joists 440 may tend to the appropriate angle and be retained as a bundle until installation.

Referring now to FIG. 13 there is shown joist or rafter dealer 400 with rafters 444 at an angle to match a roof pitch. Referring also to FIG. 14 there is shown joist or rafter dealer 400 with joists 446 at a horizontal location to match a level floor.

Referring now to FIG. 15 there is shown a section of a rafter 460 and ridge beam 462 showing a rafter pinning technique. Although the pinning technique is being shown with respect to rafter 460 and ridge beam 462, the technique and/or variations of the technique may be applied to the rafter sole plate joint, joist joints or any suitable joint, for example as described in the aforementioned U.S. Patent Application filed on the same date as the instant application. Pin(s) 464 is placed accurately into the ends of rafter 460 and may be set accurately in place using a Pin Setter or manual jig. In alternate embodiments, stick machine 80 may set the pin(s) accurately or any suitable device may set the pin(s). Although only one pin is shown, any suitable number of pins may be provided with mating features on any suitable mating surface. Ridge beam 462 is shown having mating hole 466 drilled at adjoining rafter locations to ensure accurate, fast and safe placement of rafter 460. Clip 468 may extend over ridge beam 462 and may be used to ensure the pin 464 does not slide out of the hole 466 prior to fastening. Alternatively, a preset nail 470 may be located in the top of the rafter 460 that is immediately set by a hammer or otherwise once the pin 464 is fully inserted into the ridge beam 462. Alternative embodiments may include the use of two pins, a pin and a nail pilot hole or simply an accurately placed nail and an accurate nail pilot hole.

Referring now to FIG. 16 there is shown load offset gripper 482. In the embodiment shown, load offset gripper 482 may have a single vertical axis with a load cell or otherwise to lift and lower a load 486 where floor 488 supports a fraction of load 486 weight during placement as will be described. Load Offset Gripper 482 may be a device placed just above gripper 484 used to transport wall panels, joists, rafters and other building materials on site. In the exemplary embodiment shown, gripper 484 is used in conjunction with crane 110 to transport wall section 486 into position on floor 488. Load offset gripper 482 incorporates a load cell, strain gauge or otherwise to measure the tension in lifting member 490. Load offset gripper 482 may incorporate fine actuation of the load in direction 492 between lifting member 490 and gripper 484 to enable the tension to be controlled such that the load appears to have a significantly lighter weight to operators positioning the load into its final position. In operation, load offset gripper 482 detects the load associated with panel 486 before and/or during transport to determine the weight of panel 486. As panel 486 is being placed, load offset gripper 482 detects a decrease in the load and does not allow it to go below some threshold, for example, a given load or a percentage of the weight of the load. Upon completion of placement, load offset gripper 482 releases the load in position and allows for gripper 484 to be release. In alternate embodiments, load offset gripper 482 may provide feedback to crane 110 where crane 110 controls the load that load offset gripper 482 may apply during placement. In alternative embodiments, Load offset gripper 482 may alternatively comprise a tension spring with a spring constant set for approximately the weight of the load being transported and placed. In this embodiment, the extension of the spring may be limited by a rigid link or coupling to prevent over-extension.

Referring now to FIG. 17 there is shown process flow diagram 500 showing a method of building a structure at a job site. The method of building has step 502 of dividing the structure into multiple substructures, the multiple substructures defining the structure. Step 504 of selecting at least one construction automation module adapted to assist in assembly of the structure at the job site is provided, the at least one construction automation module provided at the job site. Step 506 of defining a material kit for at least one substructure, the material kit having components is provided. Step 508 of identifying automation assisted components of the material kit as one or more of the components identified to be handled by the at least one construction automation module is provided. Step 510 of fabricating the material kit for the at least one substructure is provided, the components of the material kit being pre cut to length and size. Step 512 of delivering the material kit to the job site is provided. Step 514 of supplying the automation assisted components of the material kit to the automation component is provided. Step 516 of assembling the substructure using the automation component is provided.

In accordance with an exemplary method, a method of building a structure at a job site is provided, the method comprising dividing the structure into multiple substructures, the multiple substructures defining the structure; selecting at least one construction automation module adapted to assist in assembly of the structure at the job site, the at least one construction automation module provided at the job site; defining a material kit for at least one substructure, the material kit having components; identifying automation assisted components of the material kit as one or more of the components identified to be handled by the at least one construction automation module; fabricating the material kit for the at least one substructure, the components of the material kit being precut to length and size; delivering the material kit to the job site; supplying the automation assisted components of the material kit to the automation component; and assembling the substructure using the automation component is provided.

In accordance with an exemplary embodiment, a system for building a structure at a job site is provided. The system has at least one material automation fabrication component arranged to fabricate predetermined construction material. A controller is communicably connected to the at least one material automation fabrication component and programmed to generate commands and instructions for fabrication of the predetermined construction material into at least one kit of predetermined construction material. The controller is configured to interface with at least one field assembly automation component having a predetermined automation function for sequential erection of the structure from the at least one kit of predetermined construction material. The controller is programmed to associate the at least one kit of predetermined construction material with the at least one field assembly automation component and to generate with the at least one material automation fabrication component the at least one kit of predetermined construction material associated with the at least one field assembly automation component.

In another exemplary method, a method of building a structure at a job site is provided comprising providing at least one material automation fabrication component arranged to fabricate predetermined construction material; fabricating the predetermined construction material into at least one kit of predetermined construction material; providing at least one field assembly automation component having a predetermined automation function for sequential erection of the structure from the at least one kit of predetermined construction material; associating the at least one kit of predetermined construction material with the at least one field assembly automation component; and generating with the at least one material automation fabrication component the at least one kit of predetermined construction material associated with the at least one field assembly automation component.

It should be understood that the foregoing description is only illustrative of the invention. Various alternatives and modifications can be devised by those skilled in the art without departing from the invention. For example, some or all of the disclosed embodiments above may use voice control. By way of further example, some or all of the embodiments disclosed may operate in an automatic, semi automatic or manual power assisted mode. Accordingly, the present invention is intended to embrace all such alternatives, modifications and variances.

What is claimed is:

1. A method of building a structure at a job site, the method of building comprising:
dividing the structure into multiple substructures, the multiple substructures defining the structure;
selecting at least one construction automation module configured to assist in assembly of the structure at the job site, the at least one construction automation module provided at the job site;
defining a material kit for at least one substructure, the material kit having components;
identify automation assisted components of the material kit as one or more of the components identified to be handled by the at least one construction automation module;
fabricating the material kit for the at least one substructure; the components of the material kit being pre cut to length and size,
delivering the material kit to the job site;
supplying the automation assisted components of the material kit to the automation component;
assembling the substructure using the automation component.

2. The method of claim 1 wherein the at least one construction automation module comprises more than one construction automation modules each with a different construction automation function, the material kit comprising different kits of predetermined construction material associated with each different construction automation function.

3. The method of claim 1 wherein the at least one construction automation module comprises more than one construction automation module each with a different construction automation function, the material kit comprising different kits of predetermined construction material associated with each different construction automation function, each of the more than one construction automation modules operating at a different time in a construction build sequence.

4. The method of claim 1 wherein the at least one construction automation module comprises more than one construction automation module each with a different construction automation function, the material kit comprising different kits of predetermined construction material associated with each different construction automation function, each of the more than one construction automation modules operating at a different time in a construction build sequence, the different kits of predetermined construction material produced and provided in accordance with the construction build sequence.

5. The method of claim 1, wherein the material kit comprises different kits of predetermined construction material sequenced for sequential installation by the at least one construction automation module in a construction build sequence.

6. The method of claim 1, wherein the material kit is provided with a corresponding at least one construction automation module to the job site in sequence for sequential installation by the at least one construction automation module in a construction build sequence.

7. The method of claim 1 wherein the at least one construction automation module comprises more than one construction automation module each with a different construction automation function, the material kit comprising different kits of predetermined construction material associated with each different construction automation function, the different kits of predetermined construction material having different handling features associated with each different construction automation function.

8. The method of claim 1 wherein the at least one construction automation module comprises more than one construction automation module each with a different construction automation function, the material kit comprising different kits of predetermined construction material associated with each different construction automation function, the different kits of predetermined construction material having different locating features associated with locating each different kits of predetermined construction material with respect to each other.

9. A system for building a structure at a job site, the system comprising:
at least one material automation fabrication component arranged to fabricate predetermined construction material;
a controller communicably connected to the at least one material automation fabrication component and programmed to generate commands and instructions for fabrication of the predetermined construction material into at least one kit of predetermined construction material;
the controller being configured to interface with at least one field assembly automation component having a predetermined automation function for sequential erection of the structure from the at least one kit of predetermined construction material; and
the controller being programmed to associate the at least one kit of predetermined construction material with the at least one field assembly automation component and to generate with the at least one material automation fabrication component the at least one kit of predetermined construction material associated with the at least one field assembly automation component.

10. The system of claim 9 wherein the at least one field assembly automation component comprises more than one field assembly automation component each with a different field assembly automation function, the controller programmed to generate different kits of predetermined construction material associated with each different field assembly automation function.

11. The system of claim 9 wherein the at least one field assembly automation component comprises more than one field assembly automation component each with a different field assembly automation function, the controller programmed to generate different kits of predetermined construction material associated with each different field assembly automation function, each of the more than one field assembly automation components operating at a different time in a construction build sequence.

12. The system of claim 9 wherein the at least one field assembly automation component comprises more than one field assembly automation component each with a different field assembly automation function, the controller programmed to generate different kits of predetermined construction material associated with each different field assembly automation function, each of the more than one field assembly automation components operating at a different time in a construction build sequence, the different kits of predetermined construction material produced and provided in accordance with the construction build sequence.

13. The system of claim 9, wherein the at least one kit of construction material is sequenced for sequential installation by the at least one field assembly automation components in a construction build sequence.

14. The system of claim 9, wherein the at least one kit of construction material is provided with a corresponding at least one field assembly automation component to the job site in sequence for sequential installation by the at least one field assembly automation components in a construction build sequence.

15. The system of claim 9 wherein the at least one field assembly automation component comprises more than one field assembly automation component each with a different field assembly automation function, the controller programmed to generate different kits of predetermined construction material associated with each different field assembly automation function, the different kits of predetermined construction material having different handling features associated with each different field assembly automation function.

16. The system of claim 9 wherein the at least one field assembly automation component comprises more than one field assembly automation component each with a different field assembly automation function, the controller programmed to generate different kits of predetermined construction material associated with each different field assembly automation function, the different kits of predetermined construction material having different locating features associated with locating each different kits of predetermined construction material with respect to each other.

17. A method of building a structure at a job site, the method comprising:
providing at least one material automation fabrication component arranged to fabricate predetermined construction material;
fabricating the predetermined construction material into at least one kit of predetermined construction material;
providing at least one field assembly automation component having a predetermined automation function for sequential erection of the structure from the at least one kit of predetermined construction material;
associating the at least one kit of predetermined construction material with the at least one field assembly automation component; and
generating with the at least one material automation fabrication component the at least one kit of predetermined construction material associated with the at least one field assembly automation component.

18. The method of claim 17 wherein the at least one field assembly automation component comprises more than one field assembly automation component each with a different field assembly automation function, the method further comprising generating different kits of predetermined construction material associated with each different field assembly automation function.

19. The method of claim 17 wherein the at least one field assembly automation component comprises more than one field assembly automation component each with a different field assembly automation function, the method further comprising generating different kits of predetermined construction material associated with each different field assembly automation function, each of the more than one field assembly automation components operating at a different time in a construction build sequence.

20. The method of claim 17 wherein the at least one field assembly automation component comprises more than one field assembly automation component each with a different field assembly automation function, the method further comprising generating different kits of predetermined construction material associated with each different field assembly automation function, each of the more than one field assembly automation components operating at a different time in a construction build sequence, the different kits of predetermined construction material produced and provided in accordance with the construction build sequence.

21. The method of claim 17, wherein the at least one kit of construction material is sequenced for sequential installation by the at least one field assembly automation components in a construction build sequence.

22. The method of claim 17, wherein the at least one kit of construction material is provided with a corresponding at least one field assembly automation component to the job site in sequence for sequential installation by the at least one field assembly automation components in a construction build sequence.

23. The method of claim 17 wherein the at least one field assembly automation component comprises more than one field assembly automation component each with a different field assembly automation function, the method further comprising generating different kits of predetermined construction material associated with each different field assembly automation function, the different kits of predetermined construction material having different handling features associated with each different field assembly automation function.

24. The method of claim 17 wherein the at least one field assembly automation component comprises more than one field assembly automation component each with a different field assembly automation function, the method further comprising generating different kits of predetermined construction material associated with each different field assembly automation function, the different kits of predetermined construction material having different locating features associated with locating each different kits of predetermined construction material with respect to each other.
